(19) United States
(12) Patent Application Publication
(10) Pub. No.: US 2025/0300344 A1
(43) Pub. Date: Sep. 25, 2025

(54) FRAME-INTEGRATED ANTENNA

(71) Applicant: Meta Platforms Technologies, LLC, Menlo Park, CA (US)

(72) Inventors: Huan Liao, San Jose, CA (US); Chia-Ching Lin, San Jose, CA (US); Javier Rodriguez De Luis, Kirkland, WA (US); Nil Apaydin, Kirkland, WA (US); Liang Han, Sunnyvale, CA (US)

(21) Appl. No.: 18/611,451

(22) Filed: Mar. 20, 2024

(51) Int. Cl. H01Q 1/27; G02C 11/00; H01Q 1/22; H01Q 13/10

(52) U.S. Cl. CPC H01Q 1/273; G02C 11/10; H01Q 1/22; H01Q 13/10

(57) ABSTRACT

The disclosed system may include (1) a support structure (e.g., a frame), (2) a lens, mounted to the support structure, and (3) a slot antenna (e.g., an open-ended slot antenna) formed from the support structure. Various other wearable devices, apparatuses, and methods of manufacturing are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system with a frame-integrated antenna (e.g., a slot antenna).

FIG. 2 depicts an exemplary side view of a pair of glasses with a frame-integrated antenna (e.g., a slot antenna).

FIG. 3 depicts an exemplary method of manufacture corresponding to the system of FIG. 1.

FIG. 4 depicts an exemplary augmented-reality system that may include the antenna described in connection with FIGS. 1-3.

FIG. 5 depicts an exemplary virtual-reality system that may include the antenna described in connection with FIGS. 1-3.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This disclosure is generally directed to an antenna (e.g., a slot antenna) used in an artificial reality context. In some examples, the antenna may be formed from a frame (e.g., in a pair of artificial reality glasses). In one embodiment, to reduce the size of the antenna, the antenna may be open-ended (e.g., enabling a size of the antenna to be configured as a quarter-wavelength of a working frequency of the antenna instead of a half-wavelength of the working frequency).

The antenna may be positioned at a variety of locations within a frame. In some examples, the antenna may be positioned within a rim of the frame outside of a corner area of the rim (e.g., outside of the area next to the hinges of the artificial reality glasses). This application identifies the corner area (where antennas may traditionally be located) as a less-than-ideal area for an antenna because of other elements that may typically be located there (e.g., other elements such as a main logic board, a camera module, a wifi module, etc.). By forming the antenna from a non-corner area of the rim, there may be (1) more room for the antenna (e.g., allowing a larger surface area to be dedicated to the antenna) and (2) less interference from other elements of the frame. In some examples, the antenna may be formed from a distal portion of the rim (e.g., configured to be positioned distal to an eye of a user when the frame is worn by the user). In some examples, the antenna may take the form of an L-shape. In one such example, the antenna may cut across a portion of the front frame horizontally and across a portion of the back frame vertically. As an alternate example, the antenna may cut across a portion of the back frame horizontally and across a portion of the front frame vertically.

Features from any of the embodiments described herein may be used in combination with one another in accordance with the general principles described herein. These and other embodiments, features, and advantages will be more fully understood upon reading the following detailed description in conjunction with the accompanying drawings and claims.

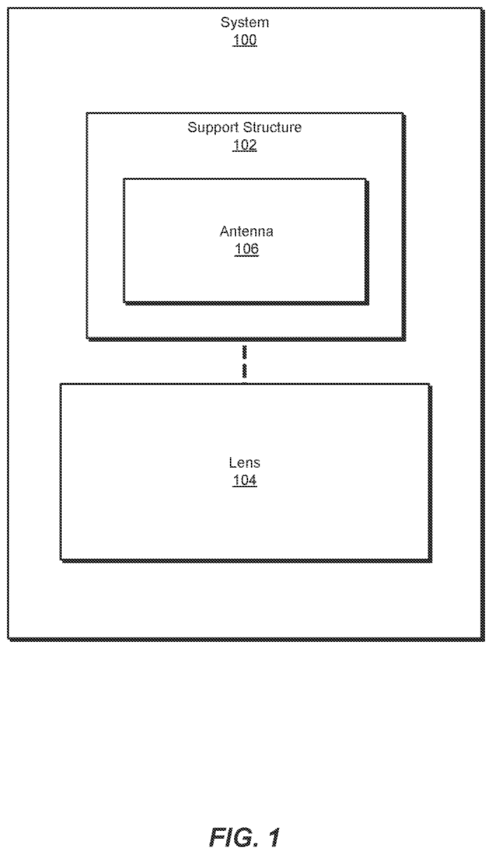

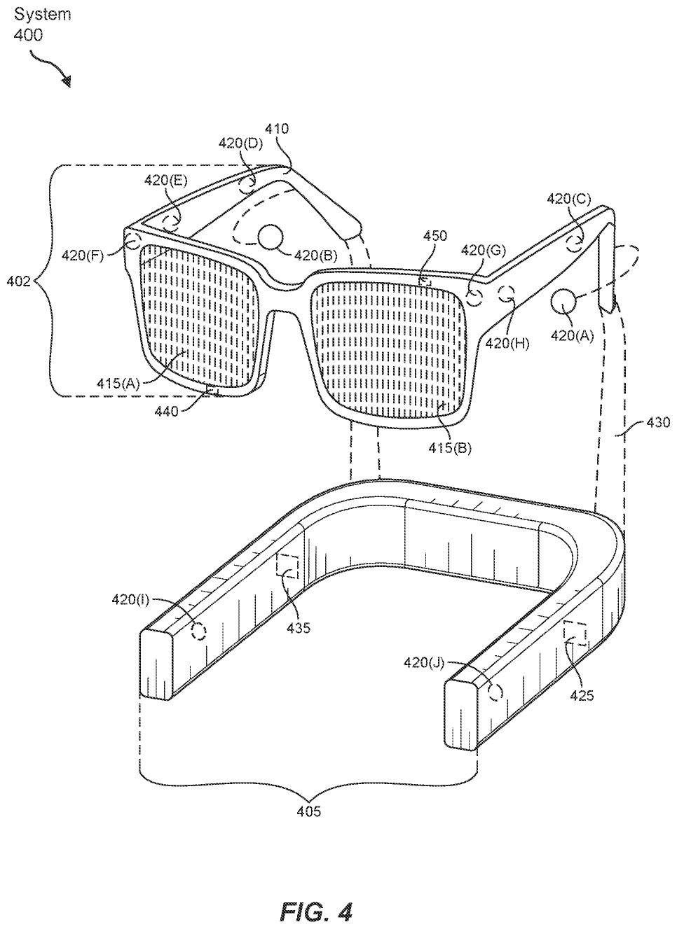

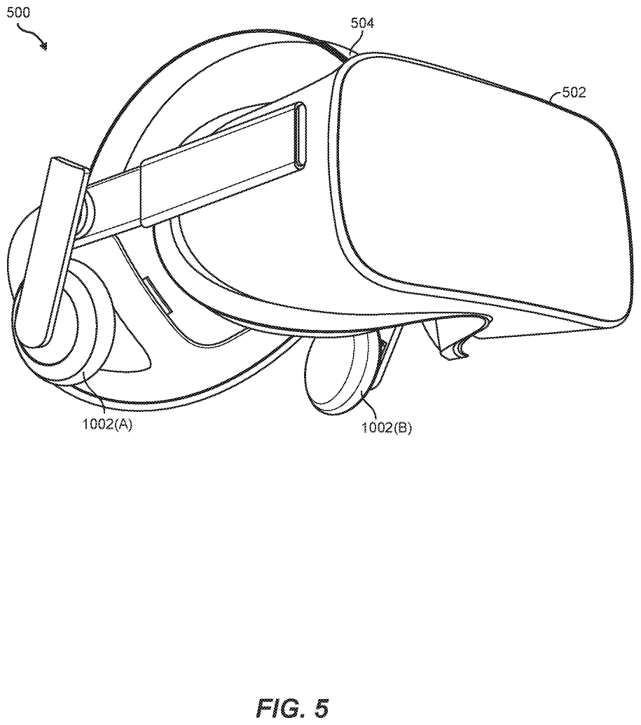

FIG. 1 illustrates an embodiment of a system 100 with a support structure 102 coupled to a lens 104. Support structure 102 may include an antenna 106 (e.g., that is formed from support structure 102). In some examples, system 100 may correspond to a wearable device (e.g., a pair of augmented reality glasses, a wearable artificial reality headset, etc.). FIGS. 4 and 5 will provide a detailed description of exemplary wearable devices.

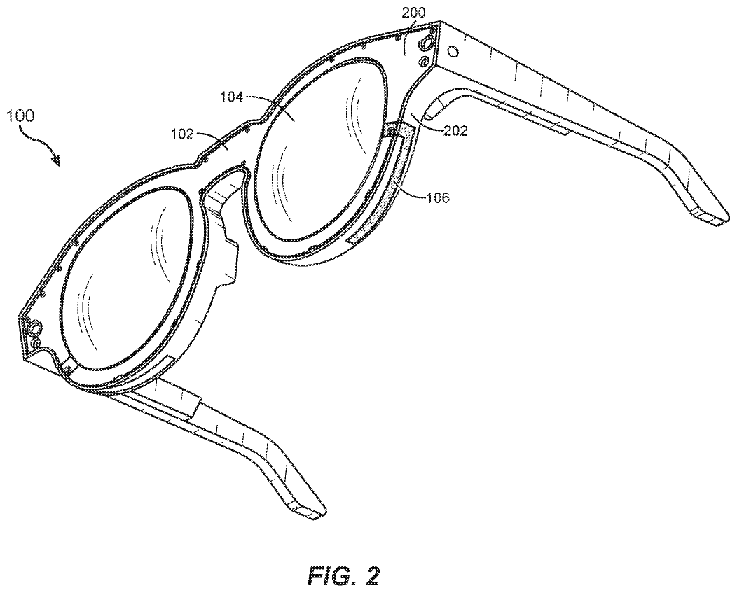

Lens 104 may represent any type or form of optical substrate and support structure 102 may represent any type or form of metal structure that physically supports lens 104. In some examples, support structure 102 may represent a component of a wearable device and lens 104 may represent an electronic display placed within the wearable device. In one example, as illustrated in FIGS. 2 and 4, lens 104 may represent a lens within a pair of augmented reality glasses and support structure 102 may represent a frame.

Antenna 106 may refer to any type or form of device that transmits and/or receives radio frequency signals. In some examples (e.g., in which system 100 corresponds to a wearable device such as a pair of artificial reality glasses), the antenna may enable wireless communication (e.g., enabling system 100 to establish a connection with other devices, networks, or sensors). In some examples, antenna 106 may refer to a slot antenna. The term “slot antenna” may refer to any type or form of antenna that is formed by cutting an opening (e.g., a narrow slot) into a conductive material (e.g., metal). In these examples, the slot antenna may be formed from a metallic portion of support structure 102 (e.g., support structure 102 may represent a metal frame and the slot antenna may be formed from the metal frame). After forming the slot antenna, with proper feeding structure, the slot antenna may transmit or receive signals by radiating electromagnetic waves.

In some examples, antenna 106 may represent a closed slot antenna that is closed at both ends (e.g., at both ends of a slot formed in support structure 102). In other examples, antenna 106 may represent an open-ended slot antenna that is open at one end. In some examples, the use of an open-ended slot antenna (versus a closed slot antenna) may enable the antenna size reduction. For example, for certain working frequencies, an open-ended slot antenna is quarter-wavelength long while the open-ended slot antenna is half-wavelength long, which is two times longer. In this example, the open-ended slot may, in addition to having a shorter length, have wider bandwidth. Thus, in some examples in which antenna 106 represents an open-ended slot antenna, a size of antenna 106 may be configured to be a quarter-wavelength of a working frequency of antenna 106.

In examples in which support structure 102 is a frame (e.g., for a pair of artificial reality glasses), the frame may include two or more layers (e.g., a front frame and a back frame). In some such examples, antenna 106 may be formed from a complete break in one of the layers and a partial break in the other layer. For example, antenna 106 may be formed from (1) a complete break in the front frame and a partial break in the back frame and/or (2) a complete break in the back frame and a partial break in the front frame. By only partially breaking one of the two layers, the mechanical strength of support structure 102 may be maintained (e.g., to survive being dropped etc.). FIG. 2 provides an exemplary embodiment in which antenna 106 is formed from a complete break in a front frame 200 and a partial break in a back frame 202. In this exemplary embodiment as shown in FIG. 2, the complete break in the front frame may represent a horizontal break and the partial break in the back frame may represent a vertical break, yielding an L-shaped antenna. Method 300 will describe a method for creating complete and/or partial breaks in connection with step 312. In some examples (not depicted in FIG. 2), support structure 102 may include a frame cover (e.g., a cosmetic cover) that is placed over the front frame (e.g., covering the slot antenna from view).

In examples in which system 100 is a pair of artificial reality glasses and support structure 102 is a frame that supports lens 104, the pair of artificial reality glasses may be configured to be worn by a user such that lens 104 is positioned over an eye of the user. In such examples, support structure 102 may include a rim that wraps around lens 104 and antenna 106 may be formed from a portion of the rim. In one example, antenna 106 may be formed from a portion of the rim that is away from the human head and/or face wearing system 100 (e.g., from a portion of the rim determined to be the farthest from the human head and/or face relative to the other portions of the rim). In some such examples, antenna 106 may be formed from a distal portion of the rim, configured to be positioned distal (e.g., and lateral) to the eye of the user when the pair of artificial reality glasses is being worn by the user. The distal portion of the rim may stand in contrast to a proximal portion of the rim (e.g., that is lateral to the eye but proximate to a user's nose when worn). FIG. 2 provides an exemplary illustration of an embodiment in which antenna is located in a distal portion of a rim of support structure 102. By distancing antenna 106 from the human head and/or face, the degradation caused by the human head and/or face can be minimized.

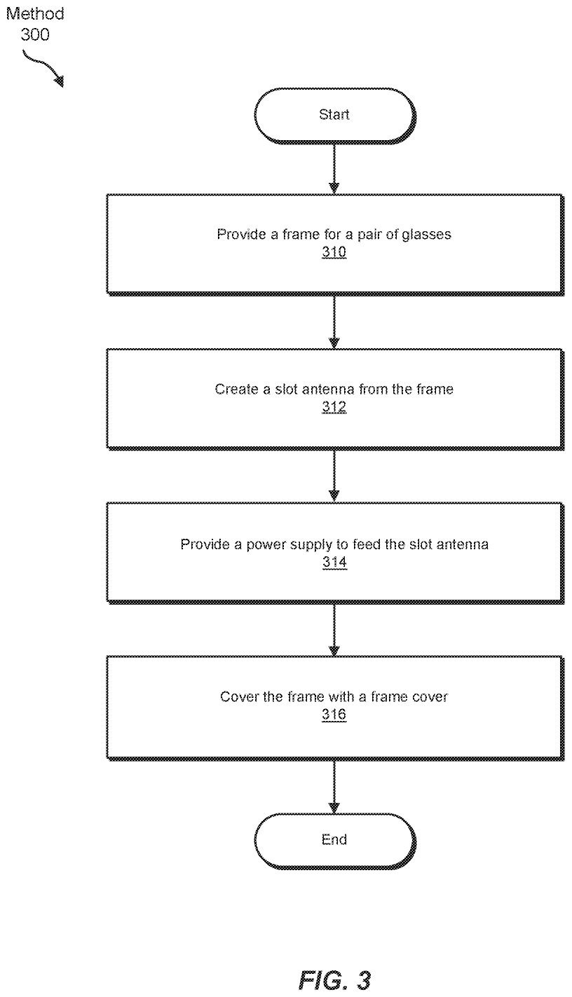

FIG. 3 depicts an exemplary method 300 of manufacture. At step 310, one or more of the systems described herein may provide a frame for a pair of glasses (e.g., support structure 102 in FIG. 1). Then, at step 312, one or more of the systems described herein may create a slot antenna (e.g., antenna 106 in FIG. 1) from the frame. In some examples, the frame may be configured to support a lens (e.g., lens 104 in FIG. 1).

The systems described herein may create the slot antenna from the frame in a variety of ways. In some examples, the frame may include a front frame, which includes a front rim, and a back frame, which includes a back rim. Both the front rim and the back rim may be configured to wrap around the lens. Both the front rim and the back rim may include an inner facet, configured to come in contact with the lens, and an outer facet, representing an outermost perimeter of the front rim or back rim. In some such examples, the system may create the slot antenna by (1) cutting a portion of the front rim yielding a complete break in the front frame between the inner facet and the outer facet of the front rim and (2) cutting a portion of the back rim without yielding a complete break in the back frame between the inner facet and the outer facet of the back rim (e.g., resulting in a slot antenna as depicted in FIG. 2). Alternatively, the system may create the slot antenna by (1) cutting a portion of the back rim yielding a complete break between the inner facet and the outer facet of the back rim and (2) cutting a portion of the front rim without yielding a complete break between the inner facet and the outer facet of the front rim (e.g., in some examples this embodiment may suffer from greater human body impact).

In some examples, the method of manufacture may include, at step 314, providing a power supply to feed the slot antenna (e.g., by (1) assembling a feeding structure and (2) coupling the feeding structure to the frame such that the feeding structure may feed the slot antenna). Then, at step 316, one or more of the systems may cover the frame with a frame cover, such as a cosmetic (e.g., non-functional) cover.

### EXAMPLE EMBODIMENTS

Example 1: A system including a support structure, a lens mounted to the support structure, and a slot antenna formed from the support structure.

Example 2: The system of example 1, where the slot antenna is open-ended.

Example 3: The system of examples 1-2, where a size of the slot antenna is a quarter-wavelength of a working frequency of the slot antenna.

Example 4: The system of examples 1-3, where the support structure is a frame.

Example 5: The system of example 4, where the frame includes a front frame and a back frame, and the slot antenna is formed from a complete break in the front frame and a partial break in the back frame.

Example 6: The system of example 4, where the frame includes a front frame and a back frame, and the slot antenna is formed from a complete break in the back frame and a partial break in the front frame.

Example 7: The system of examples 4-6, where the system is a pair of glasses, including the frame and lens, the pair of glasses is configured to be worn by a user such that the lens is positioned over an eye of the user, the frame includes a rim circumscribing the lens, and the slot antenna is located in a distal portion of the rim configured to be positioned distal to the eye of the user when the pair of glasses is worn by the user.

Example 8: A method of manufacture including providing a frame for a pair of glasses and creating a slot antenna from the frame.

Example 9: The method of manufacture of example 8, where the frame is configured to support a lens, the frame includes a front frame, including a front rim, and a back frame, including a back rim, both the front rim and back rim are configured to wrap around the lens, and both the front rim and back rim comprise an inner facet, configured to come in contact with the lens, and an outer facet, representing an outermost perimeter of the front rim or back rim.

Example 10: The method of manufacture of example 9, where creating the slot antenna from the frame includes creating the slot antenna by cutting a portion of the front rim yielding a complete break between the inner facet and the outer facet of the front rim and cutting a portion of the back rim without yielding a complete break between the inner facet and the outer facet of the back rim.

Example 11: The method of manufacture of example 9, where creating the slot antenna from the frame includes creating the slot antenna by cutting a portion of the back rim yielding a complete break between the inner facet and the outer facet of the back rim and cutting a portion of the front rim without yielding a complete break between the inner facet and the outer facet of the front rim.

Example 12: The method of manufacture of example 8, further including covering the frame with a frame cover.

Example 13: The method of manufacture of example 8, further including providing a power supply to feed the slot antenna.

Example 14: A wearable device including a support structure, a lens, mounted to the support structure, and a slot antenna formed from the support structure.

Example 15: The wearable device of example 14, where the slot antenna is open-ended.

Example 16: The wearable device of example 14, where a size of the slot antenna is a quarter-wavelength of a working frequency of the slot antenna.

Example 17: The wearable device of example 14, where the support structure is a frame.

Example 18: The wearable device of example 17, where the frame includes a front frame and a back frame, and the slot antenna is formed from a complete break in the front frame and a partial break in the back frame.

Example 19: The wearable device of example 17, where the frame includes a front frame and a back frame, and the slot antenna is formed from a complete break in the back frame and a partial break in the front frame.

Example 20: The wearable device of example 17, where the wearable device is a pair of glasses, including the frame and lens, the pair of glasses is configured to be worn by a user such that the lens is positioned over an eye of the user, the frame includes a rim circumscribing the lens, and the slot antenna is located in a distal portion of the rim configured to be positioned distal to the eye of the user when the pair of glasses is worn by the user.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof.

Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 400 in FIG. 4) or that visually immerses a user in an artificial reality (such as, e.g., virtual-reality system 500 in FIG. 5). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 4, augmented-reality system 400 may include an eyewear device 402 with a frame 410 configured to hold a left display device 415(A) and a right display device 415(B) in front of a user's eyes. Display devices 415(A) and 415(B) may act together or independently to present an image or series of images to a user. While augmented-reality system 400 includes two displays, embodiments of this disclosure may be implemented in augmented-reality systems with a single NED or more than two NEDs.

In some embodiments, augmented reality system 400 may include one or more sensors, such as sensor 440. Sensor 440 may generate measurement signals in response to motion of augmented-reality system 400 and may be located on substantially any portion of frame 410. Sensor 440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 400 may or may not include sensor 440 or may include more than one sensor. In embodiments in which sensor 440 includes an IMU, the IMU may generate calibration data based on measurement signals from sensor 440. Examples of sensor 440 may include, without limitation, accelerometers, gyroscopes, magnetometers, other suitable types of sensors that detect motion, sensors used for error correction of the IMU, or some combination thereof.

In some examples, augmented-reality system 400 may also include a microphone array with a plurality of acoustic transducers 420(A)-420(J), referred to collectively as acoustic transducers 420. Acoustic transducers 420 may represent transducers that detect air pressure variations induced by sound waves. Each acoustic transducer 420 may be configured to detect sound and convert the detected sound into an electronic format (e.g., an analog or digital format). The microphone array in FIG. 4 may include, for example, ten acoustic transducers: 420(A) and 420(B), which may be designed to be placed inside a corresponding ear of the user, acoustic transducers 420(C), 420(D), 420(E), 420(F), 420(G), and 420(H), which may be positioned at various locations on frame 410, and/or acoustic transducers 420(I) and 420(J), which may be positioned on a corresponding neckband 405.

In some embodiments, one or more of acoustic transducers 420(A)-(J) may be used as output transducers (e.g., speakers). For example, acoustic transducers 420(A) and/or 420(B) may be earbuds or any other suitable type of headphone or speaker.

The configuration of acoustic transducers 420 of the microphone array may vary. While augmented-reality system 400 is shown in FIG. 4 as having ten acoustic transducers 420, the number of acoustic transducers 420 may be greater or less than ten. In some embodiments, using higher numbers of acoustic transducers 420 may increase the amount of audio information collected and/or the sensitivity and accuracy of the audio information. In contrast, using a lower number of acoustic transducers 420 may decrease the computing power required by an associated controller 450 to process the collected audio information. In addition, the position of each acoustic transducer 420 of the microphone array may vary. For example, the position of an acoustic transducer 420 may include a defined position on the user, a defined coordinate on frame 410, an orientation associated with each acoustic transducer 420, or some combination thereof.

Acoustic transducers 420(A) and 420(B) may be positioned on different parts of the user's ear, such as behind the pinna, behind the tragus, and/or within the auricle or fossa. Or, there may be additional acoustic transducers 420 on or surrounding the ear in addition to acoustic transducers 420 inside the ear canal. Having an acoustic transducer 420 positioned next to an ear canal of a user may enable the microphone array to collect information on how sounds arrive at the ear canal. By positioning at least two of acoustic transducers 420 on either side of a user's head (e.g., as binaural microphones), augmented-reality system 400 may simulate binaural hearing and capture a 3D stereo sound field around about a user's head. In some embodiments, acoustic transducers 420(A) and 420(B) may be connected to augmented-reality system 400 via a wired connection 430, and in other embodiments acoustic transducers 420(A) and 420(B) may be connected to augmented-reality system 400 via a wireless connection (e.g., a BLUETOOTH connection). In still other embodiments, acoustic transducers 420(A) and 420(B) may not be used at all in conjunction with augmented-reality system 400.

Acoustic transducers 420 on frame 410 may be positioned in a variety of different ways, including along the length of the temples, across the bridge, above or below display devices 415(A) and 415(B), or some combination thereof. Acoustic transducers 420 may also be oriented such that the microphone array is able to detect sounds in a wide range of directions surrounding the user wearing the augmented-reality system 400. In some embodiments, an optimization process may be performed during manufacturing of augmented-reality system 400 to determine relative positioning of each acoustic transducer 420 in the microphone array.

In some examples, augmented-reality system 400 may include or be connected to an external device (e.g., a paired device), such as neckband 405. Neckband 405 generally represents any type or form of paired device. Thus, the following discussion of neckband 405 may also apply to various other paired devices, such as charging cases, smart watches, smart phones, wrist bands, other wearable devices, hand-held controllers, tablet computers, laptop computers, other external compute devices, etc.

As shown, neckband 405 may be coupled to eyewear device 402 via one or more connectors. The connectors may be wired or wireless and may include electrical and/or non-electrical (e.g., structural) components. In some cases, eyewear device 402 and neckband 405 may operate independently without any wired or wireless connection between them. While FIG. 4 illustrates the components of eyewear device 402 and neckband 405 in example locations on eyewear device 402 and neckband 405, the components may be located elsewhere and/or distributed differently on eyewear device 402 and/or neckband 405. In some embodiments, the components of eyewear device 402 and neckband 405 may be located on one or more additional peripheral devices paired with eyewear device 402, neckband 405, or some combination thereof.

Pairing external devices, such as neckband 405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 400 may be provided by a paired device or shared between a paired device and an eyewear device, thus reducing the weight, heat profile, and form factor of the eyewear device overall while still retaining desired functionality.

For example, neckband 405 may allow components that would otherwise be included on an eyewear device to be included in neckband 405 since users may tolerate a heavier weight load on their shoulders than they would tolerate on their heads. Neckband 405 may also have a larger surface area over which to diffuse and disperse heat to the ambient environment. Thus, neckband 405 may allow for greater battery and computation capacity than might otherwise have been possible on a stand-alone eyewear device. Since weight carried in neckband 405 may be less invasive to a user than weight carried in eyewear device 402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 405 may be communicatively coupled with eyewear device 402 and/or to other devices. These other devices may provide certain functions (e.g., tracking, localizing, depth mapping, processing, storage, etc.) to augmented-reality system 400. In the embodiment of FIG. 4, neckband 405 may include two acoustic transducers (e.g., 420(I) and 420(J)) that are part of the microphone array (or potentially form their own microphone subarray). Neckband 405 may also include a controller 425 and a power source 435.

Acoustic transducers 420(I) and 420(J) of neckband 405 may be configured to detect sound and convert the detected sound into an electronic format (analog or digital). In the embodiment of FIG. 4, acoustic transducers 420(I) and 420(J) may be positioned on neckband 405, thereby increasing the distance between the neckband acoustic transducers 420(I) and 420(J) and other acoustic transducers 420 positioned on eyewear device 402. In some cases, increasing the distance between acoustic transducers 420 of the microphone array may improve the accuracy of beamforming performed via the microphone array. For example, if a sound is detected by acoustic transducers 420(C) and 420(D) and the distance between acoustic transducers 420(C) and 420(D) is greater than, e.g., the distance between acoustic transducers 420(D) and 420(E), the determined source location of the detected sound may be more accurate than if the sound had been detected by acoustic transducers 420(D) and 420(E).

Controller 425 of neckband 405 may process information generated by the sensors on neckband 405 and/or augmented-reality system 400. For example, controller 425 may process information from the microphone array that describes sounds detected by the microphone array. For each detected sound, controller 425 may perform a direction-of-arrival (DOA) estimation to estimate a direction from which the detected sound arrived at the microphone array. As the microphone array detects sounds, controller 425 may populate an audio data set with the information.

In embodiments in which augmented-reality system 400 includes an inertial measurement unit, controller 425 may compute all inertial and spatial calculations from the IMU located on eyewear device 402. A connector may convey information between augmented-reality system 400 and neckband 405 and between augmented-reality system 400 and controller 425. The information may be in the form of optical data, electrical data, wireless data, or any other transmittable data form. Moving the processing of information generated by augmented-reality system 400 to neckband 405 may reduce weight and heat in eyewear device 402, making it more comfortable to the user.

Power source 435 in neckband 405 may provide power to eyewear device 402 and/or to neckband 405. Power source 435 may include, without limitation, lithium-ion batteries, lithium-polymer batteries, primary lithium batteries, alkaline batteries, or any other form of power storage. In some cases, power source 435 may be a wired power source. Including power source 435 on neckband 405 instead of on eyewear device 402 may help better distribute the weight and heat generated by power source 435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 500 in FIG. 5, that mostly or completely covers a user's field of view. Virtual-reality system 500 may include a front rigid body 502 and a band 504 shaped to fit around a user's head. Virtual-reality system 500 may also include output audio transducers 506(A) and 506(B). Furthermore, while not shown in FIG. 5, front rigid body 502 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 400 and/or virtual-reality system 500 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 400 and/or virtual-reality system 500 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 400 and/or virtual-reality system 500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world.

Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a support structure;
a lens, mounted to the support structure; and
a slot antenna formed from the support structure.

2. The system of claim 1, wherein the slot antenna is open-ended.

3. The system of claim 1, wherein a size of the slot antenna is a quarter-wavelength of a working frequency of the slot antenna.

4. The system of claim 1, wherein the support structure is a frame.

5. The system of claim 4, wherein:
the frame comprises a front frame and a back frame; and
the slot antenna is formed from a complete break in the front frame and a partial break in the back frame.

6. The system of claim 4, wherein:
the frame comprises a front frame and a back frame; and
the slot antenna is formed from a complete break in the back frame and a partial break in the front frame.

7. The system of claim 4, wherein:
the system is a pair of glasses, comprising the frame and lens;
the pair of glasses is configured to be worn by a user such that the lens is positioned over an eye of the user;
the frame comprises a rim circumscribing the lens; and
the slot antenna is located in a distal portion of the rim configured to be positioned distal to the eye of the user when the pair of glasses is worn by the user.

8. A method of manufacture comprising:
providing a frame for a pair of glasses; and
creating a slot antenna from the frame.

9. The method of manufacture of claim 8, wherein:
the frame is configured to support a lens;
the frame comprises a front frame, comprising a front rim, and a back frame, comprising a back rim;
both the front rim and back rim are configured to wrap around the lens; and
both the front rim and back rim comprise an inner facet, configured to come in contact with the lens, and an outer facet, representing an outermost perimeter of the front rim or back rim.

10. The method of manufacture of claim 9, wherein creating the slot antenna from the frame comprises creating the slot antenna by:
cutting a portion of the front rim yielding a complete break between the inner facet and the outer facet of the front rim; and
cutting a portion of the back rim without yielding a complete break between the inner facet and the outer facet of the back rim.

11. The method of manufacture of claim 9, wherein creating the slot antenna from the frame comprises creating the slot antenna by:
cutting a portion of the back rim yielding a complete break between the inner facet and the outer facet of the back rim; and
cutting a portion of the front rim without yielding a complete break between the inner facet and the outer facet of the front rim.

12. The method of manufacture of claim 8, further comprising:
covering the frame with a frame cover.

13. The method of manufacture of claim 8, further comprising:
providing a power supply to feed the slot antenna.

14. A wearable device comprising:
a support structure;
a lens, mounted to the support structure; and
a slot antenna formed from the support structure.

15. The wearable device of claim 14, wherein the slot antenna is open-ended.

16. The wearable device of claim 14, wherein a size of the slot antenna is a quarter-wavelength of a working frequency of the slot antenna.

17. The wearable device of claim 14, wherein the support structure is a frame.

18. The wearable device of claim 17, wherein:
the frame comprises a front frame and a back frame; and
the slot antenna is formed from a complete break in the front frame and a partial break in the back frame.

19. The wearable device of claim 17, wherein:
the frame comprises a front frame and a back frame; and
the slot antenna is formed from a complete break in the back frame and a partial break in the front frame.

20. The wearable device of claim 17, wherein:
the wearable device is a pair of glasses, comprising the frame and lens;
the pair of glasses is configured to be worn by a user such that the lens is positioned over an eye of the user;
the frame comprises a rim circumscribing the lens; and
the slot antenna is located in a distal portion of the rim configured to be positioned distal to the eye of the user when the pair of glasses is worn by the user.
